(19) United States
(12) Patent Application Publication
(10) Pub. No.: US 2014/0030800 A1
(43) Pub. Date: Jan. 30, 2014

(54) Methods and compositions for a multipurpose, lab-on-chip device

(71) Applicants: Jonas Moses, Houston, TX (US); Shahab Khan, Dublin, CA (US)

(72) Inventors: Jonas Moses, Houston, TX (US); Shahab Khan, Dublin, CA (US)

(21) Appl. No.: 12/753,884

(22) Filed: Apr. 4, 2010

(51) Int. Cl. G01N 21/64

(52) U.S. Cl. CPC G01N 21/64
USPC 435/288.7; 422/82.08; 422/52; 422/74; 422/68.1; 422/83

(57) ABSTRACT

Methods and compositions for developing a series of microfluidic, USB-enabled, wireless-enabled, lab-on-chip devices, designed to reduce the chain-of-custody handling of samples between sample acquisition and final reporting of data, to a single individual. These devices provide on-the-spot testing for micro- and nanoscale (molecular) analysis of blood, urine, infectious agents, toxins, measurement of therapeutic drug levels, purity-of-sample testing and presence of contaminants (toxic and non-toxic, volatile and non-volatile); and for the identification of individual components and formal compounds—elemental, biological, organic and inorganic—inclusive of foodstuffs, air, water, soil, oil and gas samples. These devices may be relatively inexpensive, ruggedly designed, lightweight and capable of being employed—depending upon the specific application—by individuals with limited training, in remote and extreme environments and settings: including combat zones, disaster areas, rural communities, tropical/arctic/desert and other inhospitable climates and challenging terrains. The device may be comprised of materials that are reclaimed, are re-usable and are recyclable.

### FIELD OF THE INVENTION

The present invention generally relates to the field of diagnostic, and/or analytical sample testing, assaying, processing and assessment. More specifically, this invention relates to the assaying of very small samples by means of a highly portable, microscale lab-on-chip device (the “μLoC”—pronounced “micro-lock”), designed and assembled in such a way that facilitates the processing of manifold sample types. The μLoC, as described, herein, focuses on use in the assaying of very small fluid, particulate and gaseous samples, in a non-laboratory-based, remote-site setting.

### BACKGROUND

In recent years, advancement in analytical and testing technologies has made it possible to measure the quantity of various matter in a sample, the constituents of various matter in a sample and the level of purity or contamination of samples of a substance.

In the field of clinical testing, for example, measurement systems based on specific reactions—such as biochemical reaction, enzyme reaction and immune reaction—have been developed, which makes it possible to measure the quantity, constituents and contamination of matter in samples of body fluids. These processes may provide diagnostic insight into all manner of secretory syndromatic processes, infectious diseases, systemic toxicology, therapeutic blood-levels and a host of other clinical data.

Attention is particularly focused on measurement of the quantity, quality, disposition and/or purity of matter in body fluids, which may reflect emergent or chronic clinical conditions—not only where testing is accomplished in a controlled laboratory setting, but also “in the field.” Successful sample analysis in a remote, hazardous, environmentally-challenging setting, under immediate, emergent and/or life-threatening circumstances, requires a simple, reliable and rapid measurement method: that is, a measurement method that shortens the time from when a sample is collected until when a measurement result is obtained and reported. Therefore, there is the real world requirement for a device that employs a simple-to-use assay system, and which is portable, inexpensive and durable.

Presently, devices of practical use supporting remote-site sample testing—whether human/animal biological samples, environmental samples (air, water, soil), fossil fuel (oil and gas) sampling, foodstuffs sampling, or a host of other such substances—are in high demand. Recent progress in the development of simpler and more portable testing systems and in microassay techniques for analyzing biogenic, chemical and other matter, sensor device techniques, sensor system techniques and microfluidic control techniques now facilitate the innovation of next-generation assaying devices. As a microscale, “mobile laboratory,” supporting remote-site testing, a lab-on-chip μLoC) device—for qualitative and/or quantitative analysis of a small sample—is proposed.

### BACKGROUND OF THE INVENTION

According to a 2009 report by The National Coalition on Health Care (a Washington DC—based Coalition, which was founded in 1990 and is non-profit and rigorously non-partisan, and is comprised of more than 70 organizations), “By several measures, health care spending continues to rise at a rapid rate and forcing businesses and families to cut back on operations and household expenses respectively. In 2008, total national health expenditures were expected to rise 6.9 percent—two times the rate of inflation. Total spending was $2.4 TRILLION in 2007, or $7900 per person. Total health care spending represented 17 percent of the gross domestic product (GDP).

U.S. health care spending is expected to increase at similar levels for the next decade reaching $4.3 TRILLION in 2017, or 20 percent of GDP. In 2008, employer health insurance premiums increased by 5.0 percent—two times the rate of inflation. The annual premium for an employer health plan covering a family of four averaged nearly $12,700. The annual premium for single coverage averaged over $4,700. Experts agree that our health care system is riddled with inefficiencies, excessive administrative expenses, inflated prices, poor management, and inappropriate care, waste and fraud. These problems significantly increase the cost of medical care and health insurance for employers and workers and affect the security of families.”

The successful diagnosis and treatment of human and animal diseases, without the use of expensive diagnostic devices and processes, is therefore one of the most sought-after and elusive emphases of modern Medicine.

Toward the goal of meeting this need in the health care marketplace, the Inventors here offer a highly portable, readily available and inexpensive series of clinical diagnostic devices, which will help to mitigate the overall health care cost burden to the United States and other countries.

However, the allied Health Care industry is not the only vertical market in which there remains a gross division between the requirements for novel, inexpensive and widely applicable technologies and the currently available technology solutions. From the United Nations 2009 Global Assessment Report on Disaster Risk Reduction:

“Drawing on detailed studies, this Global Assessment urges a radical shift in development practices, and a major new emphasis on resilience and disaster planning. Floods, droughts, storms, earthquakes, fires and other events, when combined with ‘risk drivers’ such as increasing urbanization, poor urban governance, vulnerable rural livelihoods and the decline of ecosystems, can lead to massive human misery and crippling economic losses. The risks posed by global climate change and rising sea levels carry additional grave implications for how we will live in the near future.

“While we cannot prevent natural phenomena such as earthquakes and cyclones, we can limit their impacts. The scale of any disaster is linked closely to past decisions taken by citizens and governments—or the absence of such decisions. Pre-emptive risk reduction is the key. Sound response mechanisms after the event, however effective, are never enough.”

Further: “The evidence presented in this Report shows that, globally, disaster risk is disproportionately concentrated in developing countries. Given similar levels of hazard exposure, developing countries suffer far higher levels of mortality and relative economic loss than developed countries. In general, poorer countries and those with weak governance are more at risk than wealthier, better governed countries. Disaster impacts have more serious outcomes in countries with small and vulnerable economies, including many small island developing states (SIDS) and land-locked developing countries (LLDCs), than in larger countries with more diversified economies. Even assuming constant hazard levels, global disaster risk is growing; economic loss risk is growing faster than mortality risk. In general, economic development increases a country's exposure at the same time as it decreases its vulnerability. However, in low- and middle-income countries with rapidly growing economies, exposure increases at a far faster rate than vulnerability decreases, leading to increased risk overall.

“Within many developing countries, disaster risk is also spreading extensively, manifested as a very large number of low-intensity impacts, affecting significant areas of a country's territory. Almost all these impacts are associated with weather-related hazards. Such risk patterns are expanding rapidly, driven by factors such as fast—but poorly planned and managed—urban growth and territorial occupation, which increase both the number of people and assets exposed. Increased hazard exposure is aggravated by environmental mismanagement and the decline in the regulating services provided by ecosystems. Empirical evidence at the local level shows that poorer households and communities suffer disproportionately higher levels of loss and that disaster impacts lead to poverty outcomes. The poor are less able to absorb loss and recover, and are more likely to experience both short- and long-term deteriorations in income, consumption and welfare.

“Climate change will magnify these interactions between disaster risk and poverty at all scales. On the one hand it magnifies the severity, frequency, distribution and unpredictability of weather-related and climatic hazards. At the same time, it erodes the resilience of poorer countries and communities through decreased agricultural production, increased water and energy stress, greater prevalence of disease vectors, and other effects. Even small increases in weather-related hazard due to climate change can have a large magnifying effect on risk. Critically, climate change magnifies the unevenness of risk distribution, meaning potentially drastic increases in the disaster impacts and poverty outcomes experienced by poorer, less resilient countries and communities.”

Among the conclusions this UN Report makes, there are the recommendations to:

“Promote greater synergy in hazard monitoring and risk identification, leading to comprehensive multi-hazard risk assessment, through the functional integration of the scientific and technical bodies responsible for meteorology, geology and geophysics, oceanography and environmental management, etc.”

And to:

“Subject all public investment to a cost-benefit analysis to enhance its sustainability and cost-effectiveness, and contribute significantly to the reduction of disaster risk.”

As well as to:

“Strengthen the linkages between the organizations that generate warnings and those responsible for disaster preparedness and response . . . in order to increase the effectiveness of early warning systems in risk prone communities.”

Among its strategies for addressing the primary 20 recommendations this report makes the following conclusion:

“Any further decline in the regulatory services provided by ecosystems will increase weather-related hazard. A decline in provisioning services will further increase the vulnerability of rural livelihoods, as well as the availability of water and energy in urban centres [sic]. Protecting and enhancing such ecosystem services is therefore another key policy priority. “It is cheaper and easier to manage and protect ecosystems than to restore damage . . . [a prior chapter] highlighted a number of mechanisms that are already available and that could be mainstreamed including payments for ecosystem services and integrated planning.”

Toward the goal of addressing the manifold, critical issues outlined in this UN global disaster risk report, the Inventors here offer a highly portable, readily available and inexpensive series of μLoC devices, which will help to mitigate the overall global cost burden of monitoring remote-site environmental conditions—such as water, soil and air quality; monitoring the safety and quality of foodstuffs; promoting “greater synergy in hazard monitoring and risk identification, leading to comprehensive multi-hazard risk assessment”; and facilitating communication “between the organizations that generate warnings and those responsible for disaster preparedness and response . . . in order to increase the effectiveness of early warning systems in risk prone communities.”

The Inventors have previously engaged in various studies, collaborations, investigations and activities concerning Oil and Gas exploration, Transportation Managemennt and Energy/Power Grid issues.

From a September 2009 US Department of Energy (DOE) report on Fossil Fuels:

“Even with the environmental progress of the last 20 to 30 years, the costs of environmental compliance have risen steadily in recent years and are likely to continue to rise in the future as state and federal requirements become more stringent. Today's U.S. petroleum industry spends over $9 billion a year on protecting the environment and these costs could grow in the future.

“Higher costs could cause valuable oil and gas resources, including many beneath federal lands, to become uneconomical to produce. The result would be further increases in oil imports and the nation's trade deficit, potential constraints on the availability of clean-burning natural gas, and a dampening impact on the nation's economic growth.

“Working with state and federal regulators and the oil and gas industry, the Department of Energy's Office of Fossil Energy is helping to ensure that approaches to environmental protection make technical, environmental, and economic sense. The program pursues improvements in regulatory decision making, supports development of new technologies, and helps promote energy policies that encourage more efficient and environmentally responsible oil and gas production.”

From an industry white paper (Syntex Management Systems, ca. 2009) on Transportation Management (of trucking fleets):

“Real-time asset management is critical for fleet management. Safety is a major concern where the operation of trucks, lifts and other technically advanced equipment can be dangerous without proper training and supervision. And, there is never a shortage of regulations and [they are] always changing. Capturing and managing incident and compliance information cross interstate and intrastate lines for mobile assets is a complex task.”

and regarding commercial aircraft fleets . . .

“The U.S. commercial aviation industry identified several key areas for safety improvement. One is the need to better prioritize inspection workload to activities with a greater safety risk. Another is to improve communication between leadership and field inspectors on the resolution of risks identified.”

also, concerning rail transportation . . .

“[the] American economy depends on efficient, safe, environmentally-sound and affordable freight rail. “Freight rail moves more freight than any other mode of transportation” according to the Associations of American Railroads (AAR) delivering essential commodities to the economy.”

and finally, . . .

“For transportation companies, the risk could hardly be higher: Massive operations, volatile substances, heavy machinery and of course, the human element.

“Today, these companies must also conduct and manage daily operations across far-flung enterprises. They must deal with globalization, regulatory compliance, heightened environmental pressures, mergers and acquisitions, and ever-changing business and market conditions. All of this combines to make operational risk management increasingly difficult.”

From a Center for American Progress report, on the North American Energy Grid (ca. 2009):

“Largely unchanged in generations, we are now using yesterday's technologies to power an increasingly global 21st-century economy. Previous waves of investment in electricity infrastructure were essential to building the global economic and industrial leadership that was the hallmark of the U.S. economy in the last century. As local electricity grids evolved into ever larger regional networks to connect vast swaths of the country in a complex grid system, energy became ever cheaper and more reliable.

“The results? Large, central-station generating plants used abundant coal reserves to power the steel, auto, and other manufacturing industries that provided steady employment for millions in the Midwest. Investments in hydroelectric dams created inexpensive power and brought an aluminum and aerospace industry to the Pacific Northwest. And rural electrification ensured that the benefits of access to reliable and affordable energy brought economic development to every corner of the country as a fundamental principle of American fairness—from remote communities in Appalachia to the rural South, the Great Plains, and the Southwest. Forward-thinking investments in public infrastructure and dependable access to energy have touched every state in America.

“Yet, these early-20th-century investments in our electric grid system have not kept pace with today's global economy. Today's grid cannot respond effectively to the most pressing new challenges we now face—from terrorism to global warming to ever-rising demand. Nor is our current electricity grid capable of capturing the opportunity created by recent advances in information technology; exciting new tools for producing radical gains in energy efficiency, reliability, and security; or the deployment of clean renewable energy at the scale needed to meet the clean-energy demands of a new century.

“That's why it is so important today to reinvigorate our economy by building new generation, transmission, and distribution systems for efficient use of low-carbon electricity. The transformation of our increasingly outmoded electricity infrastructure around the platforms of efficiency, security, reliability, and reduced carbon emissions will boost U.S. innovation and job creation in coming decades. Building a national clean-energy smart grid will create new markets, foster new businesses and business models, put people back to work in construction and manufacturing, and lay the foundation for long-term, sustainable economic growth.

“This task will be daunting. As presently configured, the U.S. electric transmission and distribution system faces . . . major hurdles . . . [T]he monitoring and control technology on both transmission and distribution networks is weak. The lack of smart technology to provide utilities and consumers with better information in real time hurts the security and efficiency of the entire electricity system. The lack of such a modern, smart-grid network slows the spread of new technology such as solar panels on our homes, intelligent appliances to cut our energy bills, or micro-grids to help first responders meet natural disasters . . .

“ . . . Yet just as fundamental as these current limits to bringing new renewable resources online is the sobering reality that our entire transmission grid infrastructure was developed in a pre-digital era for a completely different set of problems than we currently confront. Today's grid-related challenges are much more diverse than those of the 20th century, and solving them will require a national effort to remake the grid with new technology, new investments, and new economic, regulatory, and political arrangements in order to improve the reliability, security, and efficiency of the electric grid, and to enhance its environmental performance.

“The grid has suffered from systematic underinvestment in recent decades . . .

“ . . . A stronger power grid also will be more reliable, significantly reducing the staggering cost of power outages for U.S. consumers and businesses. The 2003 blackout in the Northeast United States and Canada, for example, caused an estimated $7 billion to $10 billion in economic losses. Today, however, we have the tools to improve real-time monitoring and control of the grid with advanced information technology. We can use this IT to better manage energy on the lines, to reduce disruptions, and to respond flexibly to disruptions when they do occur.

“These modern smart-grid technologies are not yet widely deployed, yet they have the potential to reduce billions of dollars of costs attributable to power interruptions and fluctuations across the network. The Electric Power Research Institute, for example, estimates that electricity disruptions cost the economy upward of $100 billion each year in damages and lost business. With new investments in technology, these losses are increasingly preventable.

“A more robust grid is vitally important as a matter of national security as well. Because transmission investments have not kept pace with increased demands, and advanced smart-grid technologies have not been broadly deployed, the grid is more susceptible not only to costly outages but also to both natural and man-made disasters. New grid investments are justified to make our energy infrastructure more resilient. A more interconnected grid will provide redundancy in the event of a failure in any single location and allow grid operators to respond more flexibly to emerging problems by bringing in generation from other regions.

“In addition, security experts increasingly identify cyber-security and direct terrorist threats to the grid as a substantial hazard for the entire U.S. economy, with a few targeted attacks to our existing infrastructure potentially threatening public health, safety, and commerce over vast regions. Hurricane Katrina showed starkly the debilitating consequences that power outages can have not only on citizens' daily lives but also on the welfare and functioning of entire cities, from streetlights to pumping stations to hospitals and refineries. Clearly the security and reliability of our energy supply is a matter of basic public safety. The threat of global warming makes these concerns only more acute.

“To rise to the current occasion, we must expand the grid to support dramatic increases in the penetration of renewable energy and improve its reliability, efficiency, and security . . . [T]o take rapid and meaningful action will require not only new investment, but also more thoughtful regulatory tools and policy approaches to leverage the potential for large-scale investment into a robust 21st-century electricity transmission and distribution infrastructure that is resilient, clean, efficient, and affordable to consumers.

Toward the goal of addressing the sky-rocketing costs of fossil fuel exploration—especially in light of increasingly tight regulatory controls on safe and environmentally-friendly practices and the monitoring of environmental impact during and post-exploration and during refining, shipping and storing fossil fuels and their byproducts; addressing the burdensome tasks of air, rail, ground and waterway transportation fleet management of assets, monitoring of fleet safety and maintenance; and significantly contributing to improving and enhancing “the reliability, security, and efficiency of the electric grid,” and to enhance its environmental performance while keeping the real dollar cost of such improvements at a minimum, the Inventors here offer a highly portable, easy-to-use, readily available and relatively inexpensive series of μLoC devices, which can monitor, analyze, measure, capture (data), communicate, manage, store and correlate—in real time, with little-or-no human interface requirement, at multiple sites, in harsh and/or hostile environments, wirelessly and globally, whether the acquisition and analysis of samples relates to air quality, sample purity, gas toxicity, groundwater contamination, engine wear, lubricant viscosity, power grid functionality/security and safety, or a host of other such globally-critical variables.

### SUMMARY OF THE INVENTION

The devices specifically covered herein relate to “small, and very small, sample analysis,” whether a) for the purpose of human and animal clinical lab testing, regarding typical blood, urine and other fluids—for the purpose of establishing clinical baselines, assessing health and treating illness; b) for the determination of sample quality—such as the purity of sample or the presence of contaminants (toxic and non-toxic, volatile and non-volatile); and c) for the identification of individual components and formal compounds—elemental, biological, organic and inorganic. The present invention addresses a group of devices and methodologies where said testing can be accomplished in manifold settings, including but not limited to: in a conventional heath care facility, at home, in military combat zones, remote (or rural) settings, in disaster zones—catastrophic situations such as natural disasters, industrial sites, open pit and underground mines, petroleum and gas exploration fields and small-to-large bodies of water.

Key principal advantages of this invention are its sturdy construction, microscale configuration, versatility, ease of use and low cost of manufacturing and low cost to the end-users. A singular, primary advantage of this invention over others that may share some aspects described herein, is that the entire chain-of-custody events, from the acquisition of a sample to be tested, the actual testing of the sample, the acquisition of data results, the processing of those results and the electronic storage of those data, and to the delivery of those resultant data to an unlimited number of end-users, may all be accomplished by a single individual.

Other principal advantages of this invention are its capacity to assay a wide variety of very small—liquid, solid and gaseous—samples, analyze and compile the resulting raw-assay data, store this data and transmit this data from even the most remote sites—utilizing one or more wireless technologies in the transmission of said data.

### BRIEF DESCRIPTION OF THE FIGURES

FIG. 1 is an overview of a representative embodiment of the μLoC device, where FIG. 1.1 is the outside case shell of the device; FIG. 1.2 is a USB connector; FIG. 1.3 is a slot in the case (of FIG. 1.1), which allows the insertion of a “sample cassette” into the μLoC device; FIG. 1.4a and 1.4b are two embodiments of a “sample cassette”; FIG. 1.5 is a sample-fill portal hole in the surface of the “sample cassette” (of FIG. 1.4a,b), which allows for the introduction of a fluid sample into the microfluidic network of channels and terminal chambers; FIG. 1.6 is one, representative channel of the microfluidic network of channels; FIG. 1.7 is one, representative terminal chamber; FIG. 1.8a is a protective, clear adhesive strip that sterilely seals the sample-fill portal (FIG. 1.5) until time of intended use; FIG. 1.8b is a paper or plastic pull tag, continuous with the clear adhesive strip of FIG. 1.8a, intended to be pulled in the removal of the clear adhesive strip of FIG. 1.8a; FIG. 1.9 is a paper or plastic label (the underside of which is an RFID tag), on which appears all identifying, and usage, information and markings, regarding a specific “sample cassette” (of FIG. 1.4a,b); FIG. 1.10 is one LED, representative of a full array of LEDs arranged on the PEM (photonic emission) layer of the PCB (printed circuit board) (FIG. 1.11); FIG. 1.11 is a PCB (printed circuit board); FIG. 1.12 is a Bluetooth™ chip; FIG. 1.13 is a RFID (radio frequency identification device) chip; FIG. 1.14 is a microfluidic pump; FIG. 1.15 is a grooved channel guide for the “sample cassette” (of FIG. 1.4a,b); and FIG. 1.16 is a hole in the device case (of FIG. 1.1) through which can be seen a LED indicator light, which is only illuminated (as red) when the device has reached its maximum capacity and can perform no further sample testing.

FIG. 2 is a ¾ view of the fully-encased μLoC device, where FIG. 2.1. is the device case shell (of FIG. 1.1); FIG. 2.2 is the USB connector (of FIG. 1.2); and FIG. 2.16 is the hole in the device case shell, through which can be seen a LED indicator light (of FIG. 1.16).

FIG. 3 is a top view of the PCB layer, where FIG. 3.10 is the PEM LED array (of FIG. 1.10) and FIG. 3.11 is the PCB (printed circuit board, of FIG. 1.11).

FIG. 4 is a bottom view of the PCB layer, as attached to the photoreceptor layer—of the μLoC device—where FIG. 4.11 is another view of the PCB from FIG. 1.11; 4.12 is another view of the Bluetooth™ chip of FIG. 1.12); FIG. 4.13 is another view of the RFID chip of FIG. 1.13; FIG. 4.14 is another view of the microfluidic pump from FIG. 1.14; FIG. 4.17 is a RAM chip (random access memory); FIG. 4.18 is a “wireless” Internet chip; FIG. 4.19 is representative of the other electronic integrated circuitry components—such as resistors and capacitors—that will also be resident on the PCB (of FIG. 1.11); FIG. 4.20 is a flexible wire tape connector, connecting the electronics on the PCB (of FIG. 1.11) to the photoreceptor layer (of FIG. 4.25); FIG. 4.21 is a microprocessor chip, representative of the microprocessor(s) resident in all embodiments of the μLoc devices, whereon all driver software, all analytics software, all processing software and other software products, as needed, may be stored and accessed; FIG. 4.22 is a LED indicator light, which is only illuminated (as red), to signal when the device has reached its maximum capacity and can perform no further sample testing; FIG. 4.23 is an auxiliary battery; FIG. 4.24 is a battery, representative of the main, onboard power supply for all embodiments of the μLoc devices, even though these devices may also be powered by external means, via such access as the USB connector (of FIG. 1.2); FIG. 4.25 is a photoreceptor plate.

FIG. 5 is multiple views of a disposable lancet and its use in finger pricking, to draw a small blood sample, wherein FIG. 5.26a is an example of a disposable manual stick lancet, with safety cap in place and, FIG. 5.26b, is after lancet blade tip has been exposed; FIG. 5.27 is an example of an automatically-operated lancet, about to be utilized; and FIG. 5.28 is shows a manual lancet, after a finger stick, with a drop of blood on the subject's finger tip.

### DETAILED DESCRIPTION OF THE INVENTION

While the present disclosure may be susceptible to embodiments in different forms, the embodiments described in detail herein are to be considered exemplifications of the principles of the disclosure and are not intended to be exhaustive or to limit the disclosure to the details of construction and the arrangements of components set forth in the following description.

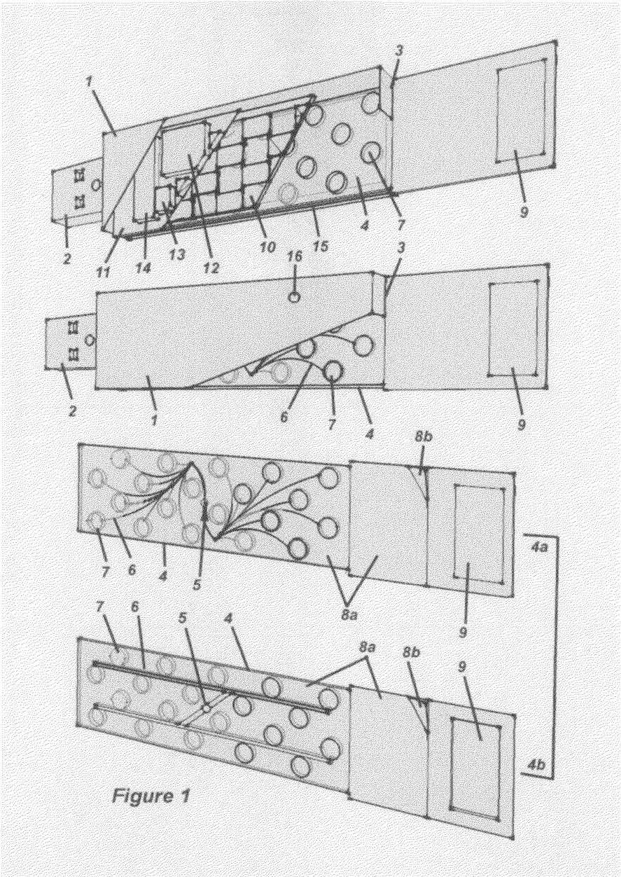

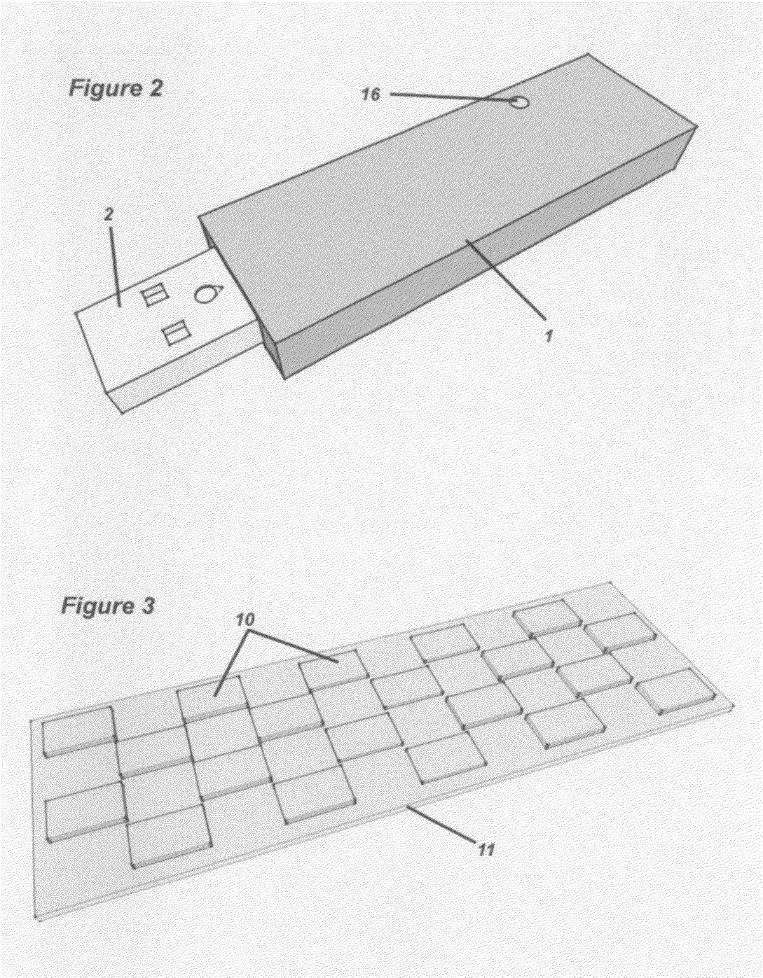

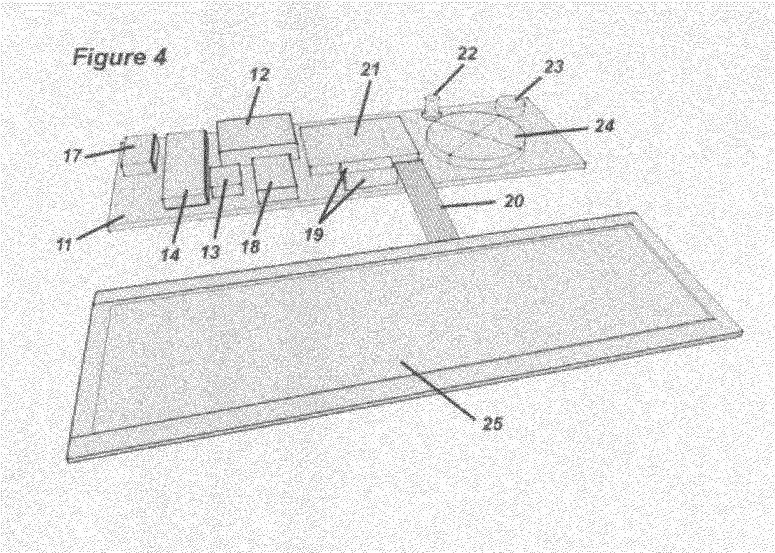

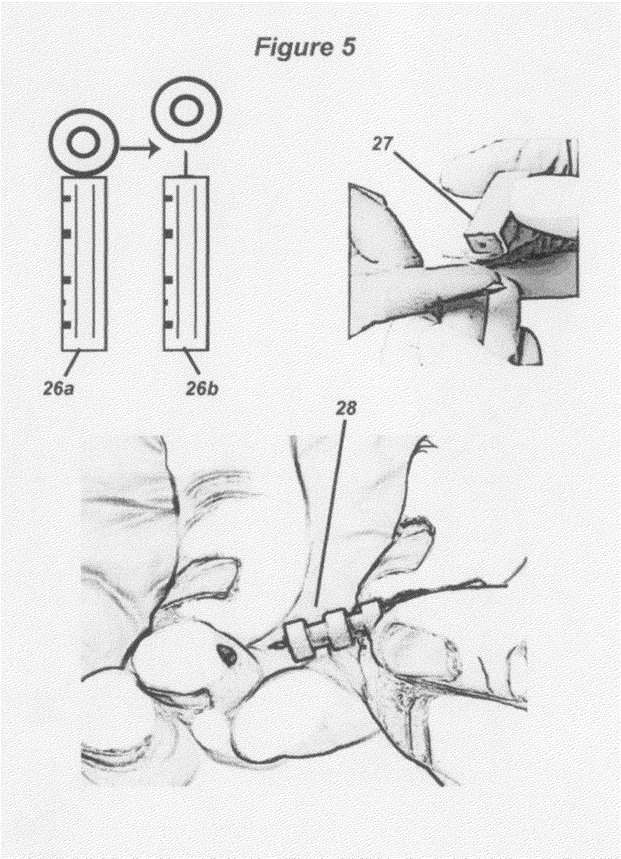

In one principal embodiment, the lab-on-chip devices are intended to be used for the on-the-spot testing and analysis of human blood, urine or other biological fluid sample, in a location remote to a standard healthcare facility setting, such as a combat zone: a) The sample is obtained from one of the subject's digits—in the instance of blood testing—using one of any of a number of commonly available, disposable sterile fmger-stick lancets (FIG. 5.26,27,28), as pre-packaged with the lab-on-chip device, along with a pre-packaged alcohol swab; b) the sterile alcohol swab is removed from its own packaging and applied to the subject's finger, from which site a small blood sample is to be obtained (FIG. 5.28); c) the finger-stick lancet, as included in the lab-on-chip's packaging, may either be designed as a spring-loaded (FIG. 5.27) and thus self-operating device that, once applied to the tip of any fmger on the subject's hand, automatically releases the lancet blade and pierces the skin just deeply enough to draw a droplet of blood, or which lancet may be manually operated, thus requiring the subject or other person to expose the lancet blade and quickly and lightly jab same into the subject's finger tip (again, rendering a droplet of blood) (FIG. 5.26,28); d) analysis is performed by pulling the paper or plastic tab end (FIG. 1.8b) of the plastic seal cover-strip (FIG. 1.8a,b) and removing the cover-strip (FIG. 1.8a,b) from the disposable sample-capture slide—the “sample cassette” (FIG. 1.4a,b)—and introducing the sample to be analyzed into the sample cassette through the cassette's sample inlet port (FIG. 1.5a,b); e) after the introduction at the sample inlet port, the fluid sample flows though a network of micro-channels (FIG. 1.6a,b) to capsule-shaped terminal assay chambers (FIG. 1.7a,b), either via capillary action, mechanical or electrical means and/or by a combination of these means; f) a reagent—or reagents, depending upon the complexity and nature of the assay involved—is/are stored in these terminal assay chambers; g) a reaction of the sample and the reagent(s) takes place within these chambers; h) for some assays, it is necessary that a primary, secondary, and tertiary reaction may transpire in additional micro-fluidic channels or chambers, in order to process a more complex multi stage reaction; i) the reactions may occur both in parallel and in series depending on the assay complexity; j) in a chemical reaction, a number of independent reactions may occur, in sequence, using a set amount of chemical reagents proportional to the variable amount of sample material being introduced; k) upon the completion of the assay, the terminal assay chamber may be flooded by excitation wavelength photonic radiation from a PCB layer (FIGS. 1.11, 4.11) whereon an array of LEDs are affixed to one side of the PCB (FIGS. 1.10, 3.10), in order to perform a spectroscopic analysis of the sample; l) the obverse side of the PCB contains several microchips (FIGS. 1, 4), one of which is a microprocessor programmed with software capable of directing the entire assay process (FIG. 4.21) and a microfluidic pump (FIGS. 1.14, 4.14); m) upon exposure to excitation photonic radiation from LEDs {as described in “k,” above} of various wavelength—ranging between 300 nm and 950 nm—the sample may react by producing emission wavelength radiation; n) the radiation emitted after excitation of the sample and reagents strikes the surface of the next layer—a photoreceptor plate (FIG. 4.25), situated on the other side of the sample cassette layer from the PCB layer, thus sandwiching the sample cassette layer between the other two (FIGS. 1, 4) o) a flexible wiring ribbon connects the PCB layer to the photoreceptor plate layer (FIG. 4.20) and raw signal data generated by the photoreceptor plate layer is sent back to the microprocessor on the PCB layer (FIG. 4.20,21,25); p) whereupon, the microprocessor analyzes and manipulates the raw data by methods including, but not limited to, calculation, interpolation, interpretation, and extrapolation; q) the raw data is then used to create diagnostic—and/or status-worthy information; r) once fully processed, the data is both stored in a RAM chip situated on the PCB layer (FIG. 4.17); s) and either manually or automatically sent, as a report file, to a clinical facility or other repository of information; t) where it can be delivered to interested parties for their reference, processing and further analysis and action-planning; and u) as well, by health care professional or other health care entities; ultimately, v) the transmission of this date is accomplished via Bluetooth microchip (FIG. 4.18), RFID microchip (FIG. 4.13) or wireless microchip (FIG. 4.12) or other such technology, resident on the PCB layer (FIGS. 1.11, 4.11)—and related chip-driver software resident in the microprocessor chip, which allows data generated by the analytical processing of a human biological sample to be packaged as email or other data-packeting format, and sent to a remote recipient. One such type of remote recipient may be a group of computer servers, connected to the World Wide Web (www) via a unique Internet Protocol (IP) address. These servers may house certain databases and software applications capable of further processing the raw analytical data—as sent from the lab-on-chip device—and packaging the data in such a way as to provide detailed reports, comparative analyses (between sample sets), gross statistical analyses (across many sample sets), trends and historical confluence, and other critical and non-critical information, to a wide variety of end-users. Among these end-users may be physicians (and other health care professionals); public health organizations; insurance providers; governmental and non-governmental local, state, regional, national and international agencies, policy-makers and analysts.

In a second primary embodiment, the devices utilize X-ray fluorescence—either transmission or back-scatter XRF—as the excitation source, in the identification of metals, and other elements, contaminants, toxins, foreign bodies and substances, and infectious agents, in oils and other viscous fluids, in water and other fluids, and in biological samples.

In a third primary embodiment, the devices are USB-based (FIGS. 1.2, 2.2) and also may include a Bluetooth microchip (FIG. 4.18), a RFID microchip (FIG. 4.13), a wireless microchip (FIG. 4.12), and related chip-driver software, which allows data generated by the analytical processing of an animal biological sample to be packaged as email and sent to a remote recipient via wireless Internet connection.

In a fourth primary embodiment, the devices are USB-based (FIGS. 1.2, 2.2) and also may include a Bluetooth microchip (FIG. 4.18), a RFID microchip (FIG. 4.13), a wireless microchip (FIG. 4.12), and related chip-driver software, which allows data generated by the analytical processing of a foodstuffs sample to be packaged as email and sent to a remote recipient via wireless Internet connection.

In a fifth primary embodiment, the devices are USB-based (FIGS. 1.2, 2.2) and also may include a Bluetooth Microchip (FIG. 4.18), a RFID microchip (FIG. 4.13), a wireless microchip (FIG. 4.12), and related chip-driver software, which allows data generated by the analytical processing of an air, water, soil, gas or oil sample to be packaged as email and sent to a remote recipient via wireless Internet connection.

### Materials and Methods

To ensure an accurate analysis of a material sample, a device may be constructed with the following components: a processing and control “center”—typically formed on a printed circuit board—that may include an analytical processor, e.g., a Cypress or Pentium micro-processor chip (or similar chip), a memory storage device and a series of resistors and capacitors and other microcircuitry, as required for the correct functioning of any of the various configurations the device may embody; a RFID tag and chipset; a Bluetooth-enabled communication micro-processor-chip; an Internet wireless telecommunications micro-processor; a USB connector and all necessary peripherals required for its use as an interface device; a microfluidics pump; a system of microfludics—microscale tubing, and channels and chambers embedded within or formed within a polymer, metal or silicate block; and DC (batteries) and/or AC power sources as necessary to provide adequate power for one or more functional utilizations of the LoC.

Where sample excitation by a photon source is required in the course of analysis, such excitation may be provided by an array of LED's (Light Emitting Diodes), with varying emitted spectra, ranging from 300 nm to 950 nm—depending upon the wavelength necessary for spectroscopic analysis of the particular assay or process being performed. This array may be referred to as the “photonic emission layer.” A photonic emission layer refers to a configuration or arrangement of means to form a path whereby radiation, such as a ray of light, is able to travel from the source to a means for receiving radiation—wherein the radiation traverses the process region and can be influenced by the sample or separated components in the sample flowing through the process region. An optical detection path is generally formed according to the invention by positioning a means of detection and analysis directly opposite each other relative to the process region. In this configuration—components in a terminal capsule, or passing through the process region, can be detected via transmission of radiation orthogonal to the major axis of the process region (and, accordingly, orthogonal to the direction of electro-osmotic flow in an electrophoretic separation).

The term “process region” is used herein to refer to a region of the device in which sample handling is carried out. Sample handling includes the entire range of operations capable of being performed on the sample from its introduction into the compartment until its removal for use. Thus, sample processing includes operations that effect sample preparation and/or sample separation. The process region frequently will include one or more sample (or access) ports for introducing materials into, and withdrawing materials from the compartment (e.g., sample, fluids and reagents).

The term “sample port” is used herein to refer to the flow path extending from any opening in the sample cassette or device by which a sample may reach its location at the terminal capsule (process region).

The actual samples for which the testing and analyses are to be performed are placed directly in contact with, or contiguous to, the photonic emission source. This sample cassette may comprise a single chamber or a series of assay chambers, connected by a distribution line that allows for them to be analyzed separately and or simultaneously. It may be, but is not limited to, an “on-board” system in which the samples are contained inside the device and, separately, as a “sample cassette” in which the samples are placed externally and then positioned inside the device, via an opening in the exterior housing. In either scenario, the terminal assay chamber(s) may be microstructures in miniaturized separation produced by micro-fabrication in a support body such as a polymeric, ceramic, glass, metal or composite substrate. Polymeric materials are preferred and include, but are not limited to, materials selected from the following classes: PDMS, polyimide, polycarbonate, polyester, polyamide, polyether, polyolefin, or mixtures thereof or may be a glass or other silicate. The interior of the sample chamber may produced by a process including but not limited to laser etching, laser ablation, injection molding and or embossing.

The phrase “laser etching” is intended to include any surface treatment of a substrate using laser light to remove material from the surface of the substrate. Accordingly, the “laser etching” includes not only laser etching but also laser machining, laser ablation, and the like. The term “laser ablation” is used to refer to a machining process using a high energy photon laser such as an Excimer laser to ablate features in a suitable. The Excimer laser can be, for example, of the F2, ArF, KrCl, KrF, or XeCl type.

The term “injection molding” is used to refer to a process for molding plastic or non-plastic ceramic shapes by injecting a measured quantity of a molten plastic or ceramic substrate into dies (or molds). In one embodiment of the present invention, microanalysis devices may be produced using injection molding.

The term “embossing” is used to refer to a process for forming polymer, metal or ceramic shapes by bringing an embossing die into contact with a pre-existing blank of polymer, metal or ceramic. A controlled force is applied between the embossing die and the pre-existing blank of material such that the pattern and shape determined by the embossing die is pressed into the pre-existing blank of polymer, metal or ceramic.

XRF Spectrometry is the choice of many analysts for elemental analysis. XRF Spectrometry easily and quickly identifies and quantifies elements over a wide dynamic concentration range, from PPM levels up to virtually 100% by weight. XRF Spectrometry does not destroy the sample and requires little, if any, sample preparation. It has a very fast overall analysis turnaround time. These factors lead to a significant reduction in the per sample analytical cost when compared to other elemental analysis techniques.

Aqueous elemental analysis instrument techniques typically require destructive and time-consuming specimen preparation, often using concentrated acids or other hazardous materials. Not only is the sample destroyed, waste streams are generated during the analysis process that need to be disposed of, many of which are hazardous. These aqueous elemental analysis techniques often take twenty minutes to several hours for sample preparation and analysis time. All of these factors lead to a relatively high cost per sample. However, if PPB and lower elemental concentrations are the primary measurement need, aqueous instrument elemental analysis techniques are necessary.

All elemental analysis techniques experience interferences, both chemical and physical in nature, and must be corrected or compensated for in order to achieve adequate analytical results. Most aqueous instrument techniques for elemental analysis suffer from interferences that are corrected for by extensive and complex sample preparation techniques, instrumentation modifications or enhancements, and by mathematical corrections in the system's software. In XRF Spectrometry, the primary interference is from other specific elements in a substance that can influence (matrix effects) the analysis of the element(s) of interest. However, these interferences are well known and documented; and, instrumentation advancements and mathematical corrections in the system's software easily and quickly correct for them. In certain cases, the geometry of the sample can affect XRF analysis, but this is easily compensated for by selecting the optimum sampling area, grinding or polishing the sample, or by pressing a pellet or making glass beads. \

“Quantitative elemental analysis” for XRF Spectrometry is typically performed using Empirical Methods (calibration curves using standards similar in property to the unknown) or Fundamental Parameters (FP). FP is frequently preferred because it allows elemental analysis to be performed without standards or calibration curves. This enables the analyst to use the system immediately, without having to spend additional time setting up individual calibration curves for the various elements and materials of interest. The capabilities of modern computers allow the use of this no-standard mathematical analysis, FP, accompanied by stored libraries of known materials, to determine not only the elemental composition of an unknown material quickly and easily, but even to identify the unknown material itself.

For a particular energy (wavelength) of fluorescent light emitted by an element, the number of photons per unit time (generally referred to as peak intensity or count rate) is related to the amount of that analyte in the sample. The counting rates for all detectable elements within a sample are usually calculated by counting, for a set amount of time, the number of photons that are detected for the various analytes' characteristic X-ray energy lines. It is important to note that these fluorescent lines are actually observed as peaks with a semi-Gaussian distribution because of the imperfect resolution of modern detector technology. Therefore, by determining the energy of the X-ray peaks in a sample's spectrum, and by calculating the count rate of the various elemental peaks, it is possible to qualitatively establish the elemental composition of the samples and to quantitatively measure the concentration of these elements.

XRF is a routine technique for the determination of major elements and many trace elements in rocks and minerals, at concentrations from 1 or 2 ppm (parts per million) to 100 per cent. Solid samples are usually prepared as glass discs for major element analyses, by fusing the sample powder with a known proportion of a commercially available flux, or as pressed powder pellets for trace-element analyses, made by mixing the sample powder with a binding agent, then pressing the mixture into a compact disc with a smooth upper surface. The sample surface is irradiated with primary X-rays, producing secondary X-rays with energies and wavelengths characteristic of the elements present. The concentration of the elements is determined by comparing the intensity of the various energy or wavelength peaks with those produced by standard samples of known composition.

As there are predominant embodiments of the present small sample analysis (μLoC) device that principally address fluid samples—oils, water and other liquids the preparation of such samples is less elaborate. Indeed, this fact is included in the Claims section as a unique claim, for the very reason that there is generally no processing or preparation of the fluid samples required, prior to analysis of the sample. At most, other than assuring that the tested fluid is measured properly before analysis begins, the person introducing the test sample into the device may be instructed to “shake” or “stir” the fluid sample briefly.

A variety of external optical detection techniques can be readily interfaced with the process region using an optical detection path including, but not limited to, UV/Visible, Near IR, fluorescence, refractive index (RI) and Raman techniques. Chromatographic Spectroscopy (“CS”), Mass Spectrometry (“MS”) and NMR are detection means well suited to yielding high quality chemical information for multi-component samples, requiring no a priori knowledge of the constituents.

Microanalysis devices and systems comprising such devices are prepared using suitable substrates as described above. A “composite” is a composition comprised of unlike materials. The composite may be a block composite, e.g., an A-B-A block composite, an A-B-C block composite, or the like. Alternatively, the composite may be a heterogeneous, i.e., in which the materials are distinct or in separate phases, or homogeneous combination of unlike materials. As used herein, the term “composite” is used to include a “laminate” composite. A “laminate” refers to a composite material formed from several different bonded layers of same or different materials. Other preferred composite substrates include, but are not limited to, polymer laminates, polymer-metal laminates, e.g., polymer coated with copper, a ceramic-in-metal or a polymer-in-metal composite.

The term “adhesion” is used herein to mean the physical attraction of the surface of one material for the surface of another. An “adhesive” is a material used to join other materials, usually solids, by means of adhesion. An “adherend” is a material to which an adhesive displays adhesion. The term “adhesive bond” is the assembly made by the joining of adherents by an adhesive.

The primary embodiments of this Lab-on-Chip device include an optically clear—or partially optically clear—chamber in which a sample of interest will be assayed, the “sample cassette.” In those embodiments wherein LEDs are used as an excitation source, in order for this cassette to block out the majority of the photons emitted from the LEDs—to ensure an accurate analysis—it is requisite that a photo-resistive barrier be adhered to the median or top portion of the sample cassette, during its fabrication. The photo-resistive layer may be comprised of a material that embodies all necessary traits commonly known in the art as well as readily allowing for polymer adhesion e.g. Al2O3, Aluminum Oxide. This photo-resistive layer allows for a specific amount of photons to move through the terminal capsules and or the process region so that a calculable amount of emitted radiation is permitted to arrive at the photo-receptor plate, without the potential for any light-scattering across the substrate.

As described above, each process region may also comprise an intra-microanalysis mechanism sample flow compartment or a serial arrangement of intra-microanalysis mechanism sample flow components and intra-microanalysis mechanism sample treatment components. Optionally, the serial arrangement of flow and treatment components can be a serial arrangement of alternating sample flow components and sample treatment components. Each sample treatment component of each microanalysis mechanism that comprises the system can perform the same or different function(s). In the case in which each sample treatment component performs the same function, the sample treatment component can be comprised of the same or different elements that affect the function.

In order to perform various assays and analyses it may be necessary to pre-lace the micro channels, terminal capsules, and any of the other various areas of the process region with chemical reagents. In many of the embodiments the device, a complex analysis will be performed, e.g. the Serial Multiple-channel Analysis 20. The SMA 20 may necessitate the use of the following reagents including but not limited to the following: BromoCresolGreen, Brij-35, 2-amino 2-methyl 1-propanol, Magnesium chloride, Sodium hydroxide, Stock paranitrophenol (PNP), disodium hydrogen phosphate dehydrate (Na2HPO4 2H20), anhydrous potassium dihydrogen phosphate (KH2POH), aspartic acid, a-keto glutarate, chloroform, AST Substrate, aspartic acid, alanine, phosphate buffer, sodium pyruvate, 2,4 dinitro-phenylhydrazine (2,4 DNPH), 1M HCI, NaOH, for example.

Additionally, so that the samples may mix thoroughly in the proper and desired capacity, a haptic layer is added to the sample cassette. This thin-film piezoelectric layer allows for the creation of a sustained vibration isolated directly at the sample cassette and thus mitigating any negative effects to the rest of the device.

A microassay device or a system of such devices can further include a method for the introduction of a “sample cassette” or other method of introduction that allows for the distribution of liquid samples, buffers, reagents, and makeup flow fluids. The manifold may be coupled to the interior surface of the microanalysis device to form an interface using pressure sealing techniques known in the art. The sample cassette and microanalysis device can be mechanically associated using friction tracks and slides, grooving, and or cavities as well as fastened using clips, tension springs or any suitable clamping means known in the art.

In order for the aforementioned samples to be introduced into the device, there must be a portal, receptacle or other access point located on either the removable “sample cassette” or centrally on the microanalysis device—in the case of a fixed non-reusable version whereby only one analysis will be performed prior to the disposal of the unit. Since it makes sense that some central location on an exposed surface of this sample cassette is the principle point of access. Further, because any samples introduced into the closed system of the sample cassette must be kept as contaminant-free as possible, the access port of this sample cassette must also be kept sealed until immediately before introduction of a sample of interest, through the sample cassette port and into the channels and chambers of the sample cassette. While various methods of sealing this port have been considered in the development of the current “μLoC” invention, one adaptable, simple-to-manufacture and use method is to seal the portal, during the manufacturing process, by applying a pre-sterilized, adhesive strip over the length of the surface of the sample cassette, into which surface said portal has been machined.

The pre-sterilized, adhesive strip described in [0026], above, may be manufactured from several, widely-used materials, including, but not limited to, polypropylene or polystyrene or other plastic film. For applications wherein long-lasting and complete sealing of an adhesive-lined, thin-film substrate to a wide variety of glass, plastic and metal surfaces, monomers which provide particularly good properties in addition to being commercially available are modifier monomers selected from the group consisting of 2-ethyl hexyl acrylate, isooctyl acrylate, and mixtures thereof, and modifier monomer selected from the group consisting of acrylic acid, isobomyl acrylate, and mixtures thereof.

Silicone pressure-sensitive adhesives, with both good adhesive qualities and excellent peelability, employed in the adhesive composition of the invention, and plastic film substrates—generally suitable for the provision of excellent tensile strength, necessary flexibility, sealing qualities inclusive of non-porosity and maintenance of sterility—are both well-known in the art. Such adhesives include, but are not limited to, blends of (i) polydiorganosiloxanes (also referred to as “silicone gums” typically having a number average molecular weight of about 5000 to about 10,000,000 preferably about 50,000 to about 1,000,000) with (ii) copolymeric silicone resins (also referred to as an “MQ resin” typically having a number average molecular weight of about 100 to about 1,000,000, preferably about 500 to about 50,000 number average molecular weight) comprising triorganosiloxy units and SiO 4/2 unit.

The term “transport region” refers to a portion of a microchannel that is formed upon enclosure of the microchannel by a top plate or bottom plate in which a corresponding features have been micro-fabricated as described below, that includes an “injection port”, a “transport region”, and a “terminal capsule.”

Another fundamental component, necessary for the accurate analysis of a material sample, is an optical, or other, detection means and/or analysis device—whereby the wavelengths of the radiation emitted from the photonic emission layer may be received, assessed, measured, and/or interpolated as necessary to aid in an accurate representation of the constituents of the process region. “Detection means” is intended to include any means, structure or configuration that allows the interrogation of a sample within a process region using analytical detection means well known in the art. Thus, a detection means may include, but is not limited, to one or more apertures, elongated apertures, optical receptors, photo-receptor plates, or grooves that communicate with the process region and allow a detection apparatus or other analysis device to be interfaced with the process region to detect an analyte passing through the process region. The device or apparatus communicates all relevant data to the “processing area” via electrical communication, chemical communication, electro-chemical communication, acoustical, vibratory or optical communication. This communication includes both direct conductive communication and indirect electromagnetic communication in which the sample or separated components in a process region and the data resulting from its analysis induce changes in an electromagnetic field and thereby provides means by which the sample or separated analytes can be detected, measured, interpreted, and or analyzed.

The term “liquid phase analysis” is used to refer to any analysis which is done on either small and/or macromolecular solutes in the liquid phase. Accordingly, “liquid phase analysis” as used herein includes chromatographic separations, electrophoretic separations, and electrochromatographic separations. These modes of separation are collectively referred to herein as “sample separation means.”

A “process region” is a portion of the device in which particular sample preparation processes are performed. Such processes include, but are not limited to, mixing, labeling, filtering, extracting, precipitating; digesting, dissolving and the like. Thus, examples of functions which may occur in the process region include, but are not limited to, bulk chromatographic separations, bulk electrophoretic separations, bulk electrochromatographic separations, mixing, labeling, filtering, extracting, precipitating, digesting and dissolving.

The term “function” used herein to describe the operating characteristic of a sample treatment component is intended to mean that the sample treatment component is used for “bulk separation” or “analytical separation” of a sample in preparation for final analysis and detection. Thus, the “function” of a sample separation chamber can be, generally, liquid or solid phase extraction, filtration, precipitation, derivatization, digestion, or the like. In addition, such functions may include but are not limited to: concentration of a sample from a dilute solution; chemical modifications of sample components; chromatographic and/or electrophoretic separation bulk of analyte components from matrix components; removal of interfering molecules and ions; and the like. When a “function” is said to be performed by an “element” it is intended that the extraction, filtration, precipitation, derivatization or digestion is performed by a medium or material that is intended to perform that function, e.g., the function of digestion can be performed by an element that is a protease. Reference to process treatment components that perform a predetermined function using the “same element” intends that each component is comprised of the same medium, matrix or material that is intended to perform that function, for example, each sample treatment component that performs the function of digestion comprises the same protease element, e.g., trypsin. Reference to sample treatment components that perform a predetermined function, using “different elements,” means that each component is comprised of a different medium, matrix or material each of which is intended to perform that function. For example, each sample treatment component that performs the function of digestion comprises a different protease—e.g., trypsin, pepsin, papain.

The phrase “bulk separation” is defined herein to mean a sample preparation process that prepares a sample for analytical separation and detection. Typically, a bulk separation process effects an enrichment of the analyte of interest in the sample. “Analytical separation” is defined as the final separation means of analyte from minor components before final analyte detection.

The term “motive force” is used to refer to any means for source to create desired microstructures (such as channels), inducing movement of a sample through any part of the process region or injection port. In this case, the plurality of samples may be multiple copies of the same sample or multiple different samples. Each process region comprises an intra-microanalysis device sample treatment component.

Additionally, the process region can also comprise an intra-microanalysis device sample flow component or a serial arrangement of intra-microanalysis device sample flow components and intra-microanalysis device sample treatment components. Optionally, the serial arrangement of flow and treatment components can be a serial arrangement of alternating sample flow components and sample treatment components. Each sample treatment component can perform the same or different function. In the case in which each sample treatment component performs the same function the sample treatment.

The internal layers, regions, sections and/or compartments of these devices may be encased in a solid resin or by other adhesive materials and the entire embodiment referred to herein may be, but is not limited to being, placed in an exterior casing. Candidate adhesive materials from either the pressure-sensitive or structural class adhesive materials can be used. Examples of adhesive materials from the class of pressure-sensitive adhesives include, but are not limited to, those from the group of acrylates, acrylate-epoxy hybrids and natural rubber. Examples of adhesive materials from the class of structural adhesives include, but are not limited to, those from the group of polyimides, acrylates, urethanes and cyanates. Still another process for effecting an adhesive bond is a welding process mediated by solvents or heat, or both solvents and heat. An example of solvent welding is the use of a non-polar volatile organic solvent to bond polymers from the class of styrenes. An example of thermal bonding is the application of heat to bond polymers from the class of acrylics. Finally, an example of effecting adhesion between polymer surfaces is ultrasonic welding. Ultrasonic welding can be successfully used in a range of classes of polymers including, but not limited to, methacrylates, styrenes, polypropylenes and acrylonitrile-butadienestyrene (ABS) co-polymers. While the examples provided above are for polymer adherends, one of skill in the art will recognize that the adherend can be a polymer, a ceramic, a glass, a metal, or a composite thereof.

When utilizing XRF, or other high energy sources, as an internal component of a particular device embodiment, the component, as well as the interior surfaces of the device casing may be lined with lead. Shielding reduces the intensity of radiation exponentially depending on the thickness. This means when added thicknesses are used, the shielding multiplies. The effectiveness of a shielding material in general increases with its density. In addition to shielding with lead sheets or foils, such materials as steel, concrete and depleted uranium—among others—may be employed in shielding against radiation.

In most of the μLoC device embodiments, primary connectivity from the device to a computer, or other devices, is accomplished via USB portal to USB portal. While there are abundant examples of USB protocols in the art, at least one protocol for such connectivity has been developed in concert with the development of the μLoC devices.

The Aston Component Matrix (AstonCM) provides USB support and connectivity via the AstonCM Communication Kemal and the AstonCM Device Kemal. USB connectivity is provided in two methods, the first of which relies upon built in Windows Win32 Kernal support. A native Windows safe file handle is generated from C# .NET components via Win32 typing. The AstonCM provides functionality to read from the USB device information such as the Vendor ID and the Product ID. These identifiers are used to validate the device is allowed to transport data over the AstonCM framework and that the client application is configured correctly.

The second method of USB connectivity relies upon the LibUSBDotNet C# USB library contained in the AstonCM Device Kernal. This library provides functionality to establish open endpoints for reading and writing data to and from USB devices. This method provides access for event driven calls and lower level functionality. Once connectivity has been established and data has been received, a data package is delivered to the AstonCM API for distribution and routing.

1. Microscale, lab-on-chip (μLoC) devices, capable of testing very small samples of a substance, Including—but not limited to—blood, urine, other bodily fluids, cell and tissue samples from humans and animals, foodstuffs, water, soil, air, oils and gasses, and may contain some components specifically designed to be reusable and some components specifically designed to be disposable. All embodiments of this invention are specifically designed for, and with the principal intention of, reducing the chain-of-custody between the acquisition of a sample to be tested and the actual testing of the sample, the acquisition of data results, the processing of those results and the electronic storage of those data, and the delivery of those resultant data to an unlimited number of end-users, to a single individual.

2. The μLoC device of claim 1, wherein the entire chain-of-custody events, from the acquisition of a sample to be tested, the actual testing of the sample, the acquisition of data results, the processing of those results and the electronic storage of those data, and to the delivery of those resultant data to an unlimited number of end-users, may all be accomplished by a single individual and may occur within a controlled environment and may also occur at other sites including, but not limited to, those sites that are remote, are combat zones, are in climatically hostile locations and those proximal to a natural or other disaster site; in or near a mining site (open pit, strip or down-hole); in or near the site of oil and gas exploration; in or near a refinery or a pipeline; on or near an onshore or offshore oil or gas drilling rig; in low gravity and low pressure environments—such as at very high altitude; in weightless and low temperature environments—such as in high planetary orbit or outer space; and in high pressure and high temperature environments—such as deep sea/ocean floor or beneath the Earth's crust.

3. The μLoC device of claim 1, wherein the multiple layers, chambers, components and regions of the device may be comprised of the following—including, but not limited to: a) an optically-clear, sample-capture cassette, layer, reservoir or chamber, made from one of several materials including—but not limited to—various silicate glasses, various plastics and other polymers and co-polymers, and which contains an embedded network of micro-channels and chambers; b) a printed circuit board (PCB) containing an array of LEDs, which can produce wavelengths from 370 nm to over 900 nm—including UV, visible light and IR—in the same or varying wavelengths, on one face of the PCB and c) the obverse face of the PCB containing a battery, a wireless Internet chip, a RFID chip, a Bluetooth chip, a microprocessor chip and a memory storage chip (RAM); and d) a layer, region or component comprised of a photonic receptor plate; e) wherein all or some of the components comprising the whole of the device may be made from various metals including, but not limited to, aluminum, stainless steel, titanium, copper and nickel, and various polymers and plastics including, but not limited to, acrylics, polycarbonates, polystyrenes, polyesters and polyurethanes; and f) wherein all or some of the components comprising the whole of the device may be made from optically transparent aluminum and g) wherein all or some of the components comprising the whole of the device may be made from composite graphene.

4. The μLoC device of claims 1, 2 and 3, wherein the principal components of the devices may be enclosed in a durable and reusable casing, and wherein there may be multiple configurations of the main assaying components within the casing, and wherein there may be various means of introducing a sample onto, into and within the casing of the devices.

5. The μLoC device of claims 1 and 3a, wherein fluid samples may be transported through an embedded network of sample-fill micro-channels and into terminal chambers via capillary action, and this capillary action may be assisted by a microfluidic pump and other electronic, mechanical, pneumatic, hydraulic and thermodynamic means.

6. The μLoC device of claims 1 and 3a, wherein fluid samples may be transported through an embedded sample-fill network of microfluidic-channels and into terminal chambers via capillary action, and this capillary action may be enhanced by the addition of extra micro-channels, contiguous with the terminal chambers, and not with the sample-fill microfluidic-channels. These additional micro-channels may alleviate the build-up of gas (O₂, for example) pressure in the sample-fill microfluidic-channel network and terminal chambers.

7. The μLoC device of claim 3a, wherein the sample capture region, layer, component—the “sample cassette”—may have an opaque mask applied to the surface facing the array of LEDs as situated on the PCB layer of claim 3b. This opaque mask is designed to prevent light-scattering from the LEDs as they fire, so as to obviate stray photons from striking the sample contents of a terminal chamber other than the intended terminal chamber.

8. The μLoC device of claim 3a, wherein the sample capture layer or reservoir or chamber—the “sample cassette”—may be single-use and disposable, may be packaged separately from the rest of the μLoC device, and may be inserted into the device through a slot in the casing of the device, or inserted or attached to the device in several other manners, only at the time of use.

9. The μLoC device of claim 1 that is comprised of multiple microscale diagnostic components and is capable of processing human biological samples, on-the-spot and in real time, from living or deceased subjects, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

10. The μLoC device of claim 1 that is comprised of multiple microscale diagnostic and assaying components and is capable of processing animal biological samples, on-the-spot and in real time, from living or deceased subjects, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

11. The μLoC device of claim 1 that is comprised of multiple microscale diagnostic and assaying components and is capable of processing soil samples, on-the-spot and in real time, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

12. The μLoC device of claim 1 that is comprised of multiple microscale diagnostic and assaying components and is capable of processing water—and other water-based, mixed-fluid—samples, on-the-spot and in real time, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

13. The μLoC device of claim 1 that is comprised of multiple microscale diagnostic and assaying components and is capable of processing air samples, on-the-spot and in real time, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

14. The μLoC device of claim 1 that is comprised of multiple microscale diagnostic and assaying components and is capable of processing samples of various oils and other fluids, including—but not limited to crude petroleum and refined petroleum fluids, sludge and sediment, on-the-spot and in real time, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

15. The μLoC device of claim 1 that is comprised of multiple microscale diagnostic and assaying components and is capable of processing samples of various foodstuffs samples, including—but not limited to—red meats, fish, poultry, pork, vegetables, fruits, legumes, roots, tubers, grains, juices and edible oils, on-the-spot and in real time, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

16. The μLoC device of claim 1 that is comprised of multiple microscale diagnostic and assaying components and is capable of processing samples of various gasses, including—but not limited to—benzene as a gas, methane as a gas, propane as a gas, helium as a gas and nitrogen as a gas, oxygen as a gas, carbon dioxide as a gas, carbon monoxide as a gas, hydrogen cyanide, nitrogen dioxide as a gas, sulfur monoxide as a gas and sulfur dioxide as a gas, radon as a gas, xenon as a gas, argon as a gas, halogen as a gas, neon as a gas, chlorine as a gas, fluorine as a gas, bromine as a gas, krypton as a gas, formaldehyde in gaseous solution, volatile organic compounds in gaseous solution and 4-phenylcyclohexene, on-the-spot and in real time, and is capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

17. The μLoC device of claim 1, wherein, through a series of chemical, photonic, mechanical, fluidic, micro-fluidic and electronic processes, various medical clinical assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

18. The μLoC device of claim 1, wherein, through a series of chemical, photonic, mechanical, fluidic, micro-fluidic and electronic processes, various forensic pathology assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

19. The μLoC device of claim 1, wherein, through a series of chemical, photonic, mechanical, fluidic, micro-fluidic and electronic processes, various air sample purity assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

20. The μLoC device of claim 1, wherein, through a series of chemical, photonic, mechanical, fluidic, micro-fluidic and electronic processes, various soil sample assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

21. The μLoC device of claim 1, wherein, through a series of chemical, photonic, mechanical, fluidic, micro-fluidic and electronic processes, various water sample assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

22. The μLoC device of claim 1, wherein, through a series of chemical, photonic, mechanical, fluidic, micro-fluidic and electronic processes, various oil sample assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

23. The μLoC device of claim 1, wherein, through a series of chemical, photonic, mechanical, fluidic, micro-fluidic and electronic processes, various gas sample assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

24. The μLoC device of claim 1, wherein, through a series of chemical, photonic, mechanical, fluidic, micro-fluidic and electronic processes, various foodstuffs sample assays are performed, on-the-spot and in real time, and the device is then capable of analyzing, manipulating, storing and transmitting sample data—through USB-port and Firewire port connectivity, and wirelessly via Internet, via Bluetooth connectivity to a cell phone or other wireless device, via satellite uplink and via RFID, automatically or manually.

25. The μLoC device of claims 1-45, wherein, through a series of chemical, photonic, mechanical, fluidic, micro-fluidic and electronic processes, sample assays are performed and resultant data regarding these assays may be compiled, processed by software resident on the Lab-on-Chip (μLoC) device and stored in a RAM chip on the Lab-on-Chip (μLoC) device, automatically or manually.

26. The μLoC device of claims 1-45, wherein a portion of the device constitutes a microfluidic pump.

27. The μLoC device of claims 1-45, wherein a portion of the device constitutes a microscale chemiluminescence assay laboratory.

28. The μLoC device of claims 1-45, wherein a portion of the device constitutes a microscale spectral analysis laboratory.

29. The μLoC device of claims 1-45, wherein a portion of the device constitutes a microscale cellular assay laboratory.

30. The μLoC device of claims 1-45, wherein a portion of the device constitutes a microscale radionuclide detection and identification laboratory.

31. The μLoC device of claims 1-45, wherein a portion of the device constitutes a means of determining sample viscosity including, but not limited to the following: a capillary tube viscometer, an automatic viscometer, another viscosity analyzer, as typically used to determine a fluid's viscosity.

32. The μLoC device of claims 1-45, wherein a portion of the device constitutes a TBN (Total base Number) analyzer and may also constitute a TAN (Total Acid Number) analyzer, as typically used in the measurement of an engine lubricant's reserve alkalinity, which aids in the control of acids formed during the combustion process.

33. The μLoC device of claims 1-45, wherein a portion of the device constitutes a TFOUT (Thin Film Oxygen Uptake Test) analyzer/component/device/region, as typically used to evaluate an engine lubricant's ability to resist heat and oxygen breakdown when contaminated with oxidized/nitrated fuel, water, and soluble metals such as lead, copper, iron, manganese and silicon.

34. The μLoC device of claims 1-45, wherein a portion of the device constitutes a Pour Point Test, as typically used in determining the lowest temperature at which a lubricant will flow.

35. The μLoC device of claims 1-, wherein a portion of the device constitutes a Noack (Volatility Test analyzer, as typically used in determining the evaporation loss of engine lubricants in high temperature service.

36. The μLoC device of claims 1-45, wherein a portion of the device constitutes a Four-Ball Wear Test analyzer, as typically used in evaluating the protection provided by engine oil under conditions of pressure and sliding motion.

37. The μLoC device of claims 1-45, wherein a portion of the device constitutes a Cold Crank Simulator Test analyzer, as typically used to determine the apparent viscosity of lubricants at low temperatures and high shear rates.

38. The μLoC device of claims 13 and 16, wherein the air sampling is specifically designed to monitor the quality of the air within close proximity to a human infant or young child (younger than five years of age). Air quality, in this context, is defined as unsafe levels of gaseous, particulate or moisture-based toxins, when compared with an internationally-defined air quality standards sampling reference for “safe air” (ASTM International-developed standards for indoor/closed space air quality).

39. The μLoC device of claims 13 and 16, wherein the air sampling is specifically designed to monitor the level of CO₂ gas (carbon dioxide gas) in the air within three cubic feet of a human infant's head (child under two years of age) (ASTM International-developed standards for indoor/ closed space, air quality).

40. The μLoC device of claims 9 and 12, wherein the sampling is specifically designed to test the potability of human breast milk, as consumed by infants and young children (neonatal to four years of age).

41. The μLoC device of claims 1-45, wherein the Aston Component Matrix software platform Technology—developed by the US-based Paddington Media company—or another, comparable software platform, may enable the one-to-many broadcasting of data directly from the μLoC device to a nearly unlimited group of recipients, globally and rapidly including, but not limited to, via USB, wireless (Internet and other), BlueTooth™, RF, GPS and other such communications technologies.

42. The μLoC device of claims 1-45, wherein the technology developed by WhenImMobile.com, or another, comparable technology, may enable uniquely robust and flexible Internet/“Web” presence and interaction, wirelessly connecting the μLoC device to Websites especially designed to work in concert with the μLoC device, regardless of the wireless device available—whether Apple iPhone™, RIM Blackberry™ or other cell phone, PDA or handheld and portable device—without the necessity for downloading of additional software to the iPhone, Blackberry or other wireless device.

43. The μLoC device of claims 1-45, in which a haptic layer is added to the sample cassette, so that the samples may mix thoroughly in the proper and desired capacity. This thin-film piezoelectric layer allows for the creation of a sustained vibration isolated directly at the sample cassette and thus mitigating any negative effects to the rest of the μLoC device. There may also be an additional vibratory source built into the device, utilizing ultrasound (high frequency) vibrations to mix the samples. This ultrasonic mixing source may also be attached to the sample cassette and altogether replace the haptic layer of the sample cassette.

44. The μLoC device of claims 1-45, wherein the entire device is comprised of materials that may be or may not be reclaimed, re-usable and/or recyclable.

45. The μLoC device of claims 1-44, wherein a portion of the sample analysis is performed utilizing XRF (X-Ray Fluorescence) technologies, including, but not limited to: an X-ray source, such as an X-ray tube; an X-ray detector; a collimator/collimators, which a) may be comprised of various elements (such as metals), polymers, silicates and other materials, and which b) is utilized in controlling the divergence of the X-rays and also attenuating the amplitude of the X-rays and which c) where the source target and collimator are different materials and may be utilized in various combination to expand the range of elements capable of being identified and quantified—as found in solid or liquid samples of interest; and wherein the XRF analysis may be accomplished both by back-scattered and transmission methods; and wherein the same device may utilize both back-scattered and transmission XRF in comparing two or more samples and this may be accomplished simultaneously; and wherein XRF analysis utilizing back-scatter and transmission methods may analyze liquid and solid samples; and wherein the liquid samples may be of microfluidic proportion and may be contained in very thin sample cassettes, of no more than 1000 microns for transmission XRF and of any thickness for back-scatter XRF.
